(19) United States
(12) Patent Application Publication
(10) Pub. No.: US 2008/0263678 A1
(43) Pub. Date: Oct. 23, 2008

(54) Path Protection

(76) Inventor: Thomas Kroll, Neulussheim (DE)

Correspondence Address: SAP/BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/737,918

(22) Filed: Apr. 20, 2007

(51) Int. Cl. H04L 9/00

(52) U.S. Cl. 726/30

(57) ABSTRACT

A software configuration management system receives a request to prevent code change to code within a filesystem path. The system also receives parameters for a trigger-based rule to protect code within the filesystem path against changes. Metadata for the trigger-based rule is extracted and dumped into a file. The file is replicated to a server. When the server receives a submission to change code within the filesystem path, the server compares the submission against the metadata in the replicated file. The submission is denied based at least in part on the trigger-based rule with which the metadata in the replicated file is associated.

### FIELD

Embodiments of the invention relate to software configuration management, and more particularly to protecting code within filesystem paths against changes.

### BACKGROUND

Software Configuration Management (SCM) systems are based on a client/server architecture. Users of SCM client programs connect to an SCM server and to user SCM client programs to transfer files between the server's file repository and individual client workstations.

SCM server(s) manage a master file repository, or depot. There can be more than one depot per server. The depots contain revisions of files under SCM system control. Files are organized in depots into directory trees, much like a large hard drive. Files in a depot are referred to as depot files or versioned files. The SCM server maintains a database to track change logs, user permissions, and which users have which files checked out at any point in time. The information stored in this database is referred to as metadata.

Many SCM systems provide a protection scheme to prevent unauthorized or inadvertent access to the depot. The protections may control various actions such as which SCM commands can be run, on which files, by whom, from which host, etc. The protections are often stored as a table in a file. Typically, one or more system administrators are authorized to modify the protection file and/or administer these protections.

Managing protections tables can be a challenge because the tables are often very large and difficult to modify. When protection tables are used to manage a large SCM installation that includes many servers, it can take a substantial amount of administrator time and effort to modify and/or update the protection table(s). In addition to the burden on system administrators, the time and effort required to maintain SCM systems using traditional protection schemes imposes practical limitations on their flexibility.

### SUMMARY

A user may desire to prevent other users from making changes to code within a filesystem path on a short-notice or temporary basis. Thus, the user can send a request to a software configuration management (SCM) system to prevent changes to the applicable code. In addition to the request, the user can specify parameters to define a trigger-based rule to protect the applicable code within the filesystem path against changes. Parameters might include specifying build lists and/or projects, filesystem locations of sources used for each build list and/or project, timeframes for applying the trigger-based rule, and/or users that are excluded from the rule (i.e., users allowed to access and/or modify the applicable code).

Metadata for the trigger-based rule is extracted and dumped into a file. The file is replicated to a server. When a user makes a request to change code within the protected filesystem path, the server compares the details of the request against the metadata in the replicated file. The submission is denied based at least in part on the trigger-based rule with which the metadata in the replicated file is associated.

### BRIEF DESCRIPTION OF THE DRAWINGS

The following description includes discussion of various figures having illustrations given by way of example of implementations of embodiments of the invention. The drawings should be understood by way of example, and not by way of limitation.

FIG. 1A is a block diagram illustrating an embodiment of an SCM system.

FIG. 1B is a block diagram illustrating another embodiment of an SCM system.

FIG. 2A is a block diagram illustrating an embodiment of path protection.

FIG. 2B is a block diagram illustrating another embodiment of path protection.

FIG. 3 is a block diagram illustrating an embodiment of a metadata distributor.

FIG. 4 is a flow diagram illustrating an embodiment of path protection.

FIG. 5 is a block diagram of an embodiment of an electronic system that implements path protections.

### DETAILED DESCRIPTION

As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive. Descriptions of certain details and implementations follow, including a description of the figures, which may depict some or all of the embodiments described below, as well as discussing other potential embodiments or implementations of the inventive concepts presented herein. An overview of embodiments of the invention is provided below, followed by a more detailed description with reference to the drawings.

The path protector described herein requires no modification of existing SCM protection tables. As used herein, SCM refers generally to any system or methodology for controlling and managing a software development project. A protection table, as used herein, refers to a table that implements a protection scheme designed to prevent unauthorized or inadvertent access to files and/or data that are stored, managed, etc.

In one embodiment, a pre-submit trigger parses a dedicated file (e.g., eXtensible Markup Language (XML) file, text file, etc.), which is exported out of a database. A pre-submit trigger, as used herein, refers to a trigger that runs before submitted contents are transferred to a server. In other words, a pre-submit trigger prevents entry of new and/or modified data if defined rule conditions associated with the trigger are satisfied.

The dedicated file includes configuration metadata that defines an area and/or location within a filesystem or depot, etc. that should be protected. Additionally, the file can include a plain text description of a rule, the identity of the requester of the rule, a time period during which the rule is to be active, and/or a list of one or more users to be excluded from the rule.

A user may desire to prevent other users from making changes to code within a filesystem path on a short-notice or temporary basis. Thus, the user can send a request to a software configuration management (SCM) system to prevent changes to the applicable code. In addition to the request, the user can specify parameters to define a trigger-based rule to protect the applicable code within the filesystem path against changes. Parameters might include specifying build lists and/or projects, filesystem locations of sources used for each build list and/or project, timeframes for applying the trigger-based rule, and/or users that are excluded from the rule (i.e., users allowed to access and/or modify the applicable code).

Metadata for the trigger-based rule is extracted and dumped into a file. The file is replicated to a server. When a user makes a request to change code within the protected filesystem path, the server compares the details of the request against the metadata in the replicated file. The submission is denied based at least in part on the trigger-based rule with which the metadata in the replicated file is associated.

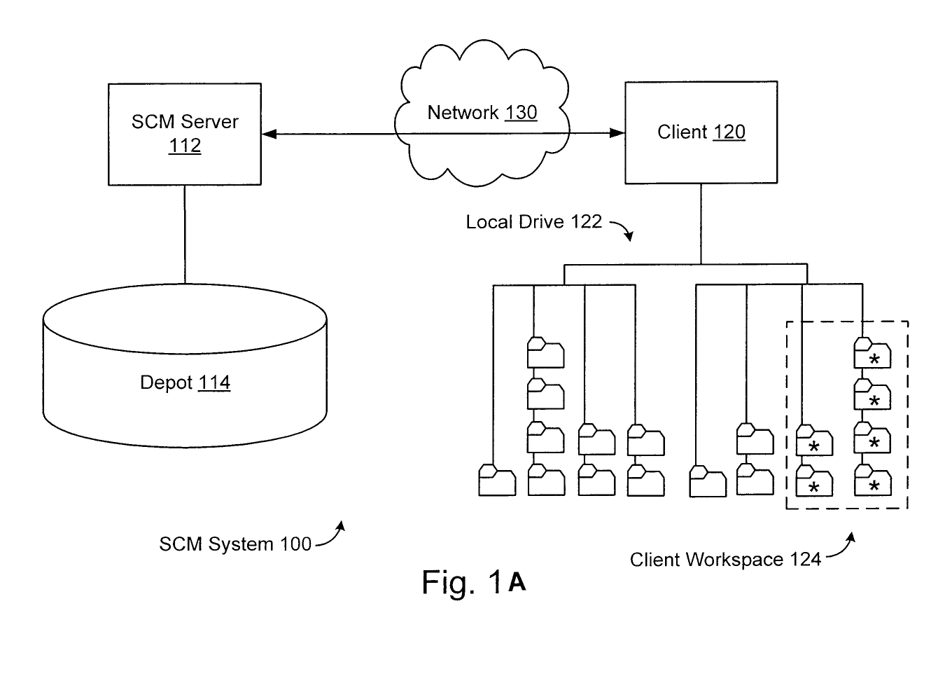

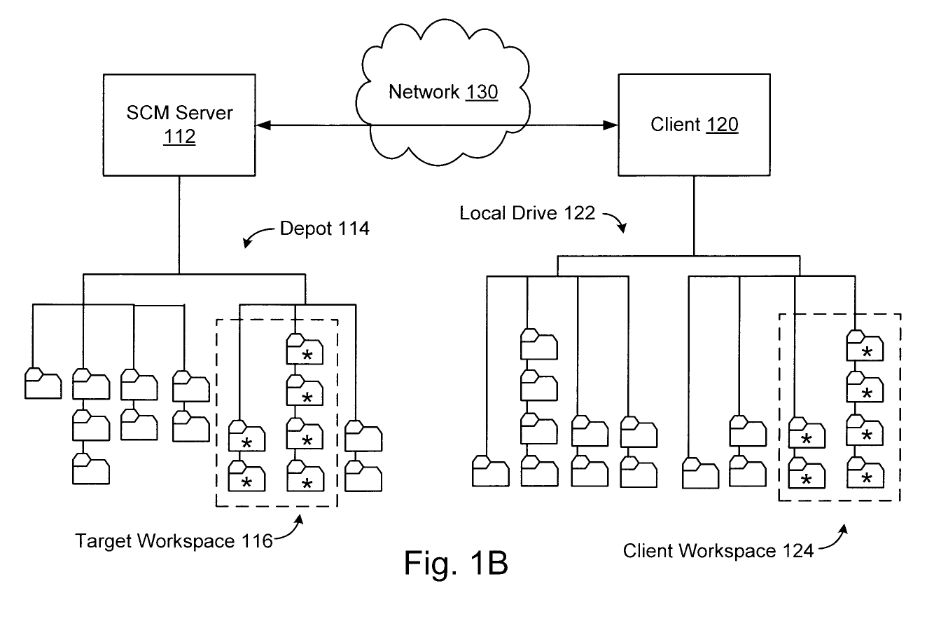

FIG. 1A is a block diagram illustrating an embodiment of an SCM system. SCM server 112 hosts a master file repository, or depot 114. For purposes of clarity and ease of description, server 112 and depot 114 are shown as single, separate entities. However, other embodiments can include multiple servers and/or multiple depots for each server.

Depot 114 contains revisions of files under the control of server 112. Files in depot 114 are organized into directory trees, like a large hard drive. This organization is further illustrated in FIG. 1B. Files stored in depot 114 are referred to herein as depot files or versioned files. Server 112 maintains a database to track change logs, timestamps, user permissions, which users have which files checked-out at any given time, etc. The information stored in this database is referred to herein as metadata.

Rather than directly modifying files in depot 114, a client program manages a specially-designated area of local drive 122 called the client workspace 124, which contains a local copy of a portion of depot 114 referred to as the target workspace 116. Thus, when client 120 user desires to change (e.g., add, delete, or modify, etc.) files in depot 114, the user submits the changes to server 112 via network 130. As used herein, the changes submitted to server 112 are referred to collectively as a “submission.” In addition to changes, a submission can include any files, data, and/or metadata sent to server 112 from client 120. Rather than use standard protection tables, the path protector described herein is used to check for unauthorized submissions.

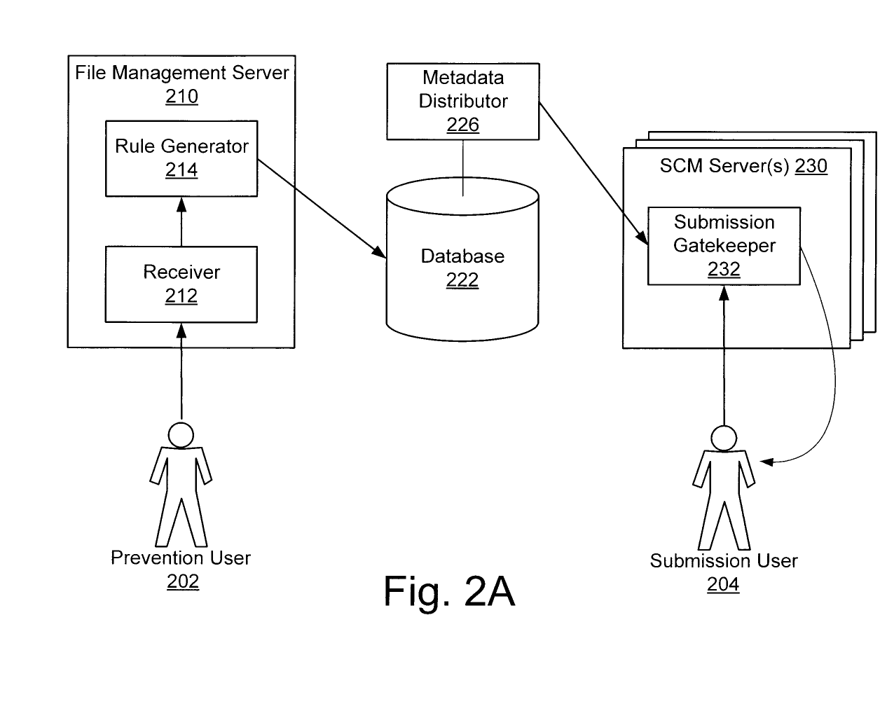

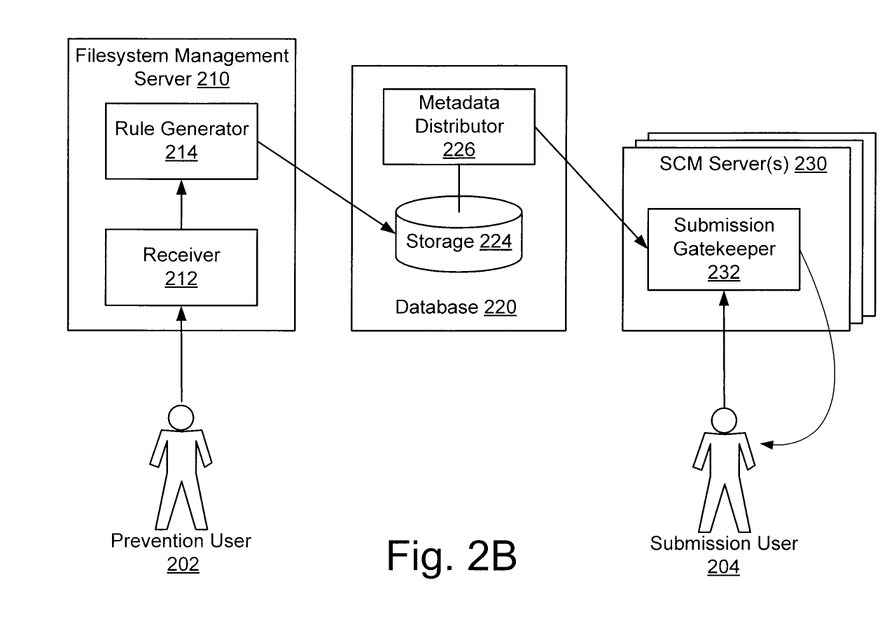

FIG. 2A illustrates an embodiment for path protection. A prevention user 202 sends a request to server 210 to prevent code changes to code within a particular filesystem path (e.g., the path corresponding to target workspace 116 of FIG. 1B). The user request is received by receiver 212 and may define a complete path, a partial path, a subset of a path, or simply define particular data, codeline(s) and/or file(s) the user wants to protect. In one embodiment, the request also includes protection parameters to be associated with the path, data, codeline(s) and/or file(s) the user wants to protect. The information (or a subset of the information) in the request is used to create a protection rule.

Protection parameters for the protection rule might include, for example, one or more specific build lists to be encompassed by the rule, a source location for each of the one or more build lists, a timeframe during which the rule is to be enforced, and a list of one or more users excluded from the rule. With respect to timeframe, the user might define a specific start time and end time or simply define a length of time during which the rule should be enforced. With respect to the excluded users list, the user might select one or more users from a list and the selected users could be users who are specifically blocked from making code changes. Conversely, selected users could be users who are specifically allowed to make code changes (while all other users are blocked from making changes).

Rule generator 214 generates a rule based on the user request and the protection parameters submitted with the request. The generated rule is written to a database, such as database 222 of FIG. 2A or database 220 of FIG. 2B. The different database arrangements in FIG. 2A and FIG. 2B are not limiting but are merely intended to illustrate the different ways in which a database and/or storage associated with a database might be described by those of skill in the art. In either FIG. 2A or FIG. 2B, rule generator 214 sends the rule to a database.

A metadata distributor 226 extracts metadata associated with the rule from the database (or storage 224 as illustrated in the embodiment of FIG. 2B). The metadata can include the rule parameters, descriptions of the rule parameters, identifiers, and/or any other information stored in association with the rule. Metadata distributor 226 dumps (or inserts, embeds, etc.) the extracted metadata into a dedicated file. The dedicated file can be an XML file, a text file, or other file type known by those skilled in the art. The dedicated file is replicated (e.g., copied) to one or more SCM servers 230.

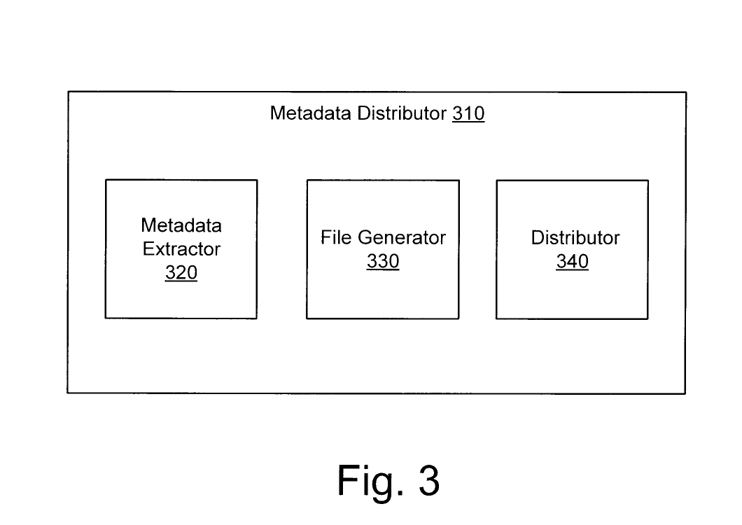

FIG. 3 illustrates in further detail one embodiment of a metadata distributor 310. Metadata extractor 320 extracts metadata associated with one or more rules from a database (e.g., database 222 of FIG. 2A). The metadata can include rule parameters, descriptions of rule parameters, rule identifiers, and/or any other information stored in association with the one or more rules. File generator 330 takes the extracted metadata and puts the metadata into a file. In one embodiment, the file is an eXtensible Markup Language (XML) file. In another embodiment, the file is a text file.

Distributor 340 receives the file generated by file generator 330 and copies it. Distributor 340 sends a copy of the file to one or more servers (e.g., server 230 of FIG. 2A and/or server 112 of FIGS. 1A-B). In one embodiment, distributor 340 sends a copy of only one file at a time. In another embodiment, distributor 340 sends a copy of multiple different files to a server in the same transmission.

Referring again to FIGS. 2A and 2B, when an SCM server 230 receives a submission from a user 204 (sent via a client device such as client 120 of FIGS. 1A and 1B), the submission is checked by submission gatekeeper 232. Submission gatekeeper 232 compares the submission against the metadata in the replicated file. If the submission includes changes to code and/or other data within a protected filesystem path and the submission is within the scope of the other parameters associated with the rule, then submission gatekeeper 232 will deny the submission and inform user 204 of the denial. In other words, if the submission satisfies the necessary rule conditions, the submission will not be accepted.

In one embodiment, a denied submission is discarded and/or deleted. In another embodiment, the submission is automatically saved by the server 230 and re-submitted based on the time parameters of the rule. For example, a rule is created that protects code X against changes from 3:00 pm to 6:00 pm on Jan. 17^{th}. If server 230 receives a submission to change code X at 5:30 pm, the submission will be denied (because 5:30 pm is between 3:00 pm and 6:00 pm).

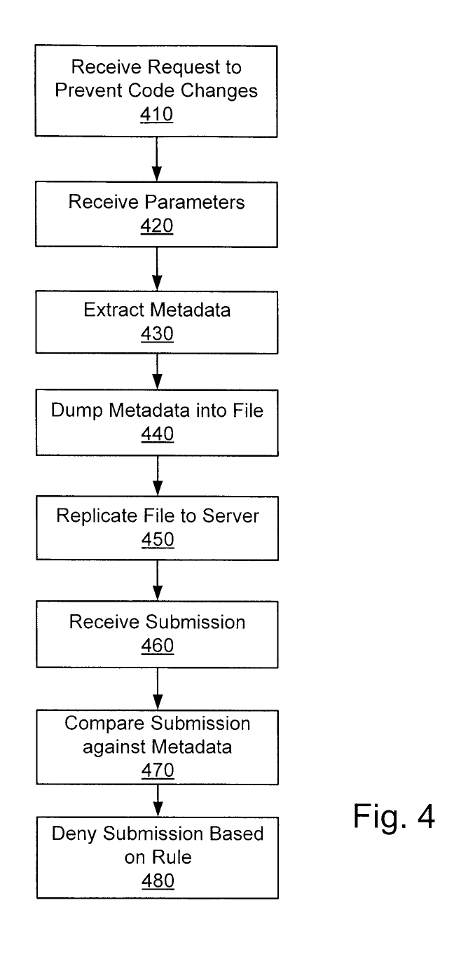

FIG. 4 is a flow diagram illustrating an embodiment of path protection. A request is received to prevent code changes to designated code within a filesystem path 410. Parameters for a trigger-based rule to protect the designated code against changes are also received 420. The parameters might include specifying build lists and/or projects, filesystem locations of sources used for each build list and/or project, timeframes for applying the trigger-based rule, and/or users that are excluded from the rule (i.e., users allowed to access and/or modify the applicable code). A rule is then generated and written to a database.

Once the rule has been created from the request and the parameters, metadata associated with the rule is extracted (e.g., from the database) and dumped in a file 430. The file can be an XML file, text file, etc. The file is replicated (e.g., copied) and sent to one or more servers 450. At some point, a server receives a submission 460 (e.g., a transmission of data and/or information to change, update, modify, etc. code and/or data). The server compares the data/information in the submission against the metadata in the replicated file 470 to determine if the submission satisfies the rule parameters. If the parameters are satisfied (i.e., the submission is one that the rule was designed to prevent), then the submission is denied 480 and the user who submitted the submission is notified.

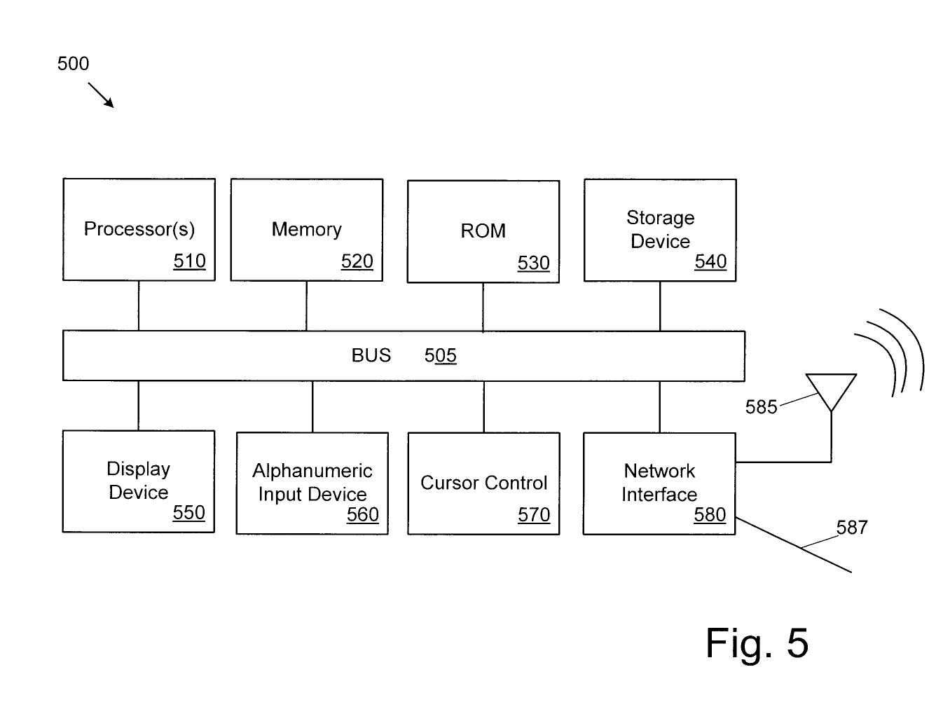

FIG. 5 is a block diagram of one embodiment of an electronic system that implements the path protections herein. The electronic system illustrated in FIG. 5 is intended to represent a range of electronic systems (either wired or wireless) including, for example, desktop computer systems, laptop computer systems, cellular telephones, personal digital assistants (PDAs) including cellular-enabled PDAs, set top boxes. Alternative electronic systems may include more, fewer and/or different components.

Electronic system 500 includes bus 505 or other communication device to communicate information, and processor 510 coupled to bus 505 that may process information. While electronic system 500 is illustrated with a single processor, electronic system 500 may include multiple processors and/or co-processors. Electronic system 500 further may include random access memory (RAM) or other dynamic storage device 520 (referred to as main memory), coupled to bus 505 and may store information and instructions that may be executed by processor 510. Main memory 520 may also be used to store temporary variables or other intermediate information during execution of instructions by processor 510.

Electronic system 500 may also include read only memory (ROM) and/or other static storage device 530 coupled to bus 505 that may store static information and instructions for processor 510. Data storage device 540 may be coupled to bus 505 to store information and instructions. Data storage device 540 such as a magnetic disk or optical disc and corresponding drive may be coupled to electronic system 500.

Electronic system 500 may also be coupled via bus 505 to display device 550, such as a cathode ray tube (CRT) or liquid crystal display (LCD), to display information to a user. Alphanumeric input device 560, including alphanumeric and other keys, may be coupled to bus 505 to communicate information and command selections to processor 510. Another type of user input device is cursor control 570, such as a mouse, a trackball, or cursor direction keys to communicate direction information and command selections to processor 510 and to control cursor movement on display 550.

Electronic system 500 further may include network interface(s) 580 to provide access to a network, such as a local area network. Network interface(s) 580 may include, for example, a wireless network interface having antenna 585, which may represent one or more antenna(e). Network interface(s) 580 may also include, for example, a wired network interface to communicate with remote devices via network cable 587, which may be, for example, an Ethernet cable, a coaxial cable, a fiber optic cable, a serial cable, or a parallel cable.

In one embodiment, network interface(s) 580 may provide access to a local area network by conforming to IEEE 802.16 standards. IEEE 802.16 corresponds to IEEE 802.15-2005 entitled “Air Interface for Fixed Broadband Wireless Access Systems” approved Dec. 7, 2005 as well as related documents.

In one embodiment, network interface(s) 580 may provide access to a local area network, for example, by conforming to IEEE 802.11b and/or IEEE 802.11g standards, and/or the wireless network interface may provide access to a personal area network, for example, by conforming to Bluetooth standards. Other wireless network interfaces and/or protocols can also be supported.

IEEE 802.11b corresponds to IEEE Std. 802.11b-1999 entitled “Local and Metropolitan Area Networks, Part 11: Wireless LAN Medium Access Control (MAC) and Physical Layer (PHY) Specifications: Higher-Speed Physical Layer Extension in the 2.4 GHz Band,” approved Sep. 16, 1999 as well as related documents. IEEE 802.11g corresponds to IEEE Std. 802.11g-2003 entitled “Local and Metropolitan Area Networks, Part 11: Wireless LAN Medium Access Control (MAC) and Physical Layer (PHY) Specifications, Amendment 4: Further Higher Rate Extension in the 2.4 GHz Band,” approved Jun. 27, 2003 as well as related documents. Bluetooth protocols are described in “Specification of the Bluetooth System: Core, Version 1.1,” published Feb. 22, 2001 by the Bluetooth Special Interest Group, Inc. Associated as well as previous or subsequent versions of the Bluetooth standard may also be supported.

In addition to, or instead of, communication via wireless LAN standards, network interface(s) 580 may provide wireless communications using, for example, Time Division, Multiple Access (TDMA) protocols, Global System for Mobile Communications (GSM) protocols, Code Division Multiple Access (CDMA) protocols, and/or any other type of wireless communications protocol.

Each component described herein may be a means for performing the functions described. Each component described herein includes software, hardware, or a combination of these. The components can be implemented as software modules, hardware modules, special-purpose hardware (e.g., application specific hardware), embedded controllers, etc. Software content (e.g., data, instructions, configuration) may be provided via an article of manufacture including a machine readable medium, which provides content that represents instructions that can be executed. The content may result in a machine performing various functions/operations described herein. A machine readable medium includes any mechanism that provides (e.g., stores and/or transmits) information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.)

A machine readable medium may also include a storage or database from which content can be downloaded. A machine readable medium may also include a device or product having content stored thereon at a time of sale or delivery. Thus, delivering a device with stored content, or offering content for download over a communication medium may understood as providing an article of manufacture with such content described herein.

Besides what is described herein, various modifications may be made to the disclosed embodiments and implementations of the invention without departing from their scope. Therefore, the illustrations and examples herein should be construed in an illustrative, and not a restrictive sense. The scope of the invention should be measured solely by reference to the claims that follow.

What is claimed is:

1. A method for path protection in a software configuration management system, the method comprising:
receiving a request to prevent code changes to code within a filesystem path;
receiving parameters for a trigger-based rule to protect code within the filesystem path against changes;
extracting metadata associated with the rule;
dumping the extracted metadata into a file;
replicating the file to at least one server;
receiving by the at least one server a submission to change code within the filesystem path;
comparing the submission against the metadata in the replicated file; and
denying the submission based at least in part on the trigger-based rule with which the metadata in the replicated file is associated.

2. The method of claim 1, further comprising:
writing the trigger-based rule and the parameters to a database; and
extracting metadata associated with the rule from the database.

3. The method of claim 1, wherein defining parameters for the trigger-based rule comprises defining:
one or more build lists to be encompassed by the rule,
a source location for each of the one or more build lists,
a timeframe during which the rule is to be enforced, and
a list of one or more users excluded from the trigger-based rule.

4. The method of claim 1, wherein the submission comprises a local workspace copy of a codeline modified by a user.

5. A path protector, comprising:
a receiver to receive a request to lock code within a filesystem path against changes during a specified time period;
a rule generator coupled with the receiver to generate a rule based at least in part on the received request;
a metadata distributor to
extract metadata associated with the rule,
insert the extracted metadata into a file, and
distribute a copy of the file to at least one server; and
a submission gatekeeper coupled with the metadata distributor to
receive a submission that includes change to code within the filesystem path,
compare the submission against the metadata in the copied file, and
trigger a denial of the submission based at least in part on the metadata.

6. The path protector of claim 5, the rule generator further to send the rule to a database and the metadata distributor further to extract metadata associated with the rule from the database.

7. The path protector of claim 5, wherein the rule specifies
one or more build lists encompassed by the rule;
a path for each of the one or more build lists;
the specified time period; and
a list of one or more users to whom the rule will not apply.

8. The path protector of claim 5, wherein the rule is an eXtensible Markup Language (XML) file.

9. An article of manufacture comprising a computer-readable medium having content stored thereon to provide instructions to result in an electronic device performing operations including:
receiving a request to prevent code changes to code within a filesystem path;
receiving parameters for a trigger-based rule to protect code within the filesystem path against changes;
extracting metadata associated with the rule;
dumping the extracted metadata into a file;
replicating the file to at least one server;
receiving by the at least one server a submission to change code within the filesystem path;
comparing the submission against the metadata in the replicated file; and
denying the submission based at least in part on the trigger-based rule with which the metadata in the replicated file is associated.

10. The article of manufacture of claim 9, further comprising content to cause the electronic device to perform operations including:
writing the trigger-based rule and the parameters to a database; and
extracting metadata associated with the rule from the database.

11. The article of manufacture of claim 9, wherein defining parameters for the trigger-based rule comprises defining:
one or more build lists to be encompassed by the rule,
a source location for each of the one or more build lists,
a timeframe during which the rule is to be enforced, and
a list of one or more users excluded from the rule.

12. The article of manufacture of claim 9, wherein the submission comprises a local workspace copy of a codeline modified by a user.

13. A path protector, comprising:
means for receiving a request to lock code within a filesystem path against changes during a specified time period;
means for generating a rule based at least in part on the received request;
means for extracting metadata associated with the rule;
means for inserting the extracted metadata into a file;
means for distributing a copy of the file to at least one server;
means for receiving a submission that includes change to code within the filesystem path;
means for comparing the submission against the metadata in the copied file; and
means for denying the submission based at least in part on the metadata.

14. The path protector of claim 13, further comprising means for sending the trigger to a database and extracting metadata associated with the rule from the database.

15. The path protector of claim 13, wherein the rule specifies
one or more build lists encompassed by the rule;
a path for each of the one or more build lists;
the specified time period; and
a list of one or more users to whom the rule will not apply.

16. The path protector of claim 5, wherein the rule is an eXtensible Markup Language (XML) file.
